(19) United States
(12) Patent Application Publication
(10) Pub. No.: US 2019/0347492 A1
(43) Pub. Date: Nov. 14, 2019

(54) VEHICLE CONTROL DEVICE

(71) Applicant: TOYOTA JIDOSHA KABUSHIKI KAISHA, Toyota-shi (JP)

(72) Inventors: Junichi MORIMURA, Sunto-gun (JP); Seiji ARAKAWA, Sunto-gun (JP)

(73) Assignee: TOYOTA JIDOSHA KABUSHIKI KAISHA, Toyota-shi (JP)

(21) Appl. No.: 16/379,953

(22) Filed: Apr. 10, 2019

(30) Foreign Application Priority Data
May 11, 2018 (JP) 2018-092122

(51) Int. Cl. G06K 9/00; G08G 1/16; B60W 40/04; G08G 1/005

(52) U.S. Cl. CPC G06K 9/00798; G08G 1/166; G06K 9/00805; B60W 40/04; G06K 9/00369; B60W 30/0956; B60W 2420/52; B60W 2420/42; B60R 2300/8033; B60R 2300/10; G08G 1/005

(57) ABSTRACT

A vehicle control device that stops a vehicle traveling with autonomous driving at a predetermined stop point includes a position estimation unit configured to estimate a position of the vehicle, a state recognition unit configured to recognize a travel state of the vehicle, a control unit configured to stop the vehicle at the stop point based on the position and the travel state of the vehicle, and a situation recognition unit configured to recognize a road-crossing moving object being present around the stop point. The control unit stops the vehicle at a first stop position with the stop point as a reference when the road-crossing moving object around the stop point is not recognized. The control unit stops the vehicle at a second stop position in front of the first stop position when the road-crossing moving object around the stop point is recognized.

### CROSS-REFERENCE TO RELATED APPLICATION

This application is based on Japanese Patent Application No. 2018-092122 filed with Japan Patent Office on May 11, 2018, the entire contents of which are hereby incorporated by reference.

### TECHNICAL FIELD

The present disclosure relates to a vehicle control device.

### BACKGROUND

Japanese Unexamined Patent Publication No. 2015-072570 discloses a vehicle control device. This device receives a movement plan of a moving object transmitted from a mobile device carried by a moving object, creates a travel plan of a vehicle according to the movement plan, and notifies a driver of the vehicle of the created travel plan. The vehicle can travel with an autonomous driving.

### SUMMARY

The vehicle control device disclosed in Japanese Unexamined Patent Publication No. 2015-072570 cannot notify the moving object who is not carrying the device of the travel plan of the autonomous driving vehicle. Therefore, for example, when a pedestrian who is not carrying the device is trying to cross the road, it is difficult for the pedestrian to determine whether the autonomous driving vehicle has an intention to make way for the pedestrian. The present disclosure provides a technology in which the intention of the autonomous driving vehicle to make way can also be transferred to the road-crossing moving object who is not carrying the device.

According to an aspect of the present disclosure, there is provided a vehicle control device that stops a vehicle traveling with autonomous driving at a predetermined stop point. The vehicle control device includes a position estimation unit configured to estimate a position of the vehicle, a state recognition unit configured to recognize a travel state of the vehicle, a control unit configured to stop the vehicle at the stop point based on the position and the travel state of the vehicle, and a situation recognition unit configured to recognize a road-crossing moving object being present around the stop point. The control unit is configured to stop the vehicle at a first stop position with the stop point as a reference when the road-crossing moving object around the stop point is not recognized by the situation recognition unit. The control unit is configured to stop the vehicle at a second stop position in front of the first stop position when the road-crossing moving object around the stop point is recognized by the situation recognition unit.

According to the device in the present disclosure, when the road-crossing moving object around the stop point is not recognized, the control unit is configured to stop the vehicle at the first stop position with the stop point as a reference, and when the road-crossing moving object around the stop point is recognized, the control unit is configured to stop the vehicle at the second stop position in front of the first stop position. That is, when the road-crossing moving object around the stop point is recognized, the device in the present disclosure can present the vehicle behavior of stopping the vehicle at the position away from the stop point or the road-crossing moving object compared to the case where the vehicle stops with the stop point as a reference, to the road-crossing moving object. In this way, the device in the present disclosure can also transfer the intention of the autonomous driving vehicle to make way to the road-crossing moving object who is not carrying the device.

The control unit in an embodiment may be configured to decelerate the vehicle from a first deceleration position determined based on the stop point when the road-crossing moving object around the stop point is not recognized by the situation recognition unit, and may be configured to decelerate the vehicle from a second deceleration position in front of the first deceleration position when the road-crossing moving object around the stop point is recognized by the situation recognition unit.

According to the device in the embodiment, when the road-crossing moving object around the stop point is not recognized, the control unit is configured to start to decelerate the vehicle from the first deceleration position determined based on the stop point, and when the road-crossing moving object around the stop point is recognized, the control unit is configured to start to decelerate the vehicle from the second deceleration position in front of the first deceleration position. That is, when the road-crossing moving object around the stop point is recognized, the device in the embodiment can present the vehicle behavior of starting the deceleration of the vehicle at a position away from the stop point or the road-crossing moving object compared to the case where the vehicle starts the deceleration with the stop point as a reference, to the road-crossing moving object. In this way, the device in the present disclosure can also notify the road-crossing moving object who is not carrying the device of the intention of the autonomous driving vehicle to make way in a more easily understandable manner.

According to various aspects of the present disclosure, the intention of the autonomous driving vehicle to make way can also be transferred to the road-crossing moving object who is not carrying the device.

### BRIEF DESCRIPTION OF THE DRAWINGS

FIG. 1 is a block diagram illustrating an example of a configuration of a vehicle that includes a vehicle control device in an embodiment.

FIG. 2 is a flowchart illustrating an example of vehicle stop processing.

FIG. 3 is a diagram illustrating an example of a speed profile.

FIG. 4A is a diagram for explaining an example of stopping the vehicle at a first stop position.

FIG. 4B is a diagram for explaining an example of stopping the vehicle at a second stop position.

### DETAILED DESCRIPTION

Hereinafter, exemplary embodiments of the present disclosure will be described with reference to the drawings. In the description below, the same reference numerals will be given to the same or equivalent elements and the descriptions thereof will not be repeated.

### Outline of Vehicle System

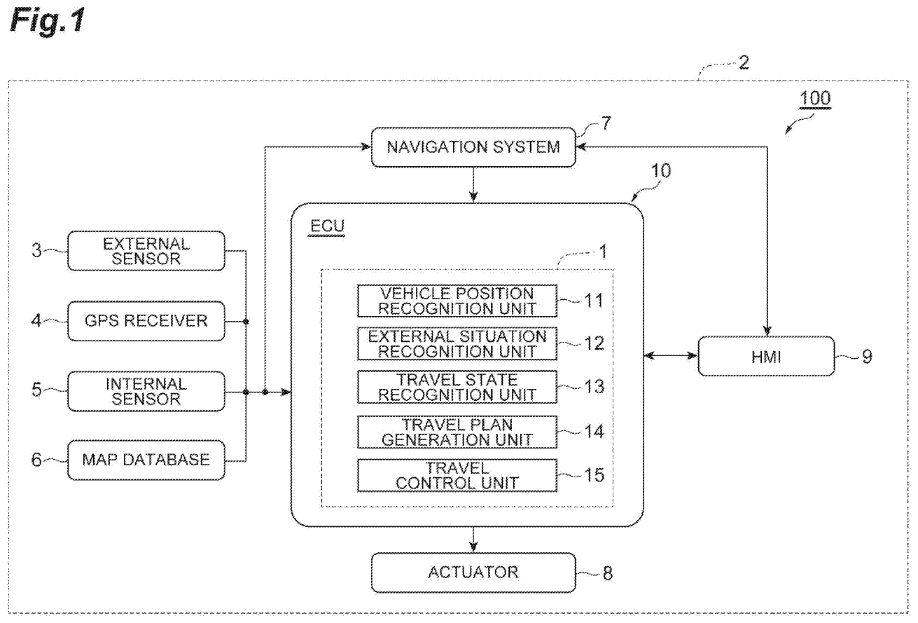

FIG. 1 is a block diagram illustrating an example of a configuration of a vehicle that includes a vehicle control device in an embodiment. As illustrated in FIG. 1, a vehicle system 100 is mounted on a vehicle 2 such as a passenger car. The vehicle system 100 is a system that causes a vehicle 2 to travel with an autonomous driving. The autonomous driving is a vehicle control for causing the vehicle 2 to autonomously travel toward a destination set in advance without a driving operation by a driver. The vehicle system 100 includes a vehicle control device 1 for stopping the vehicle 2 traveling with the autonomous driving at a predetermined stop point.

The vehicle control device 1 recognizes the predetermined stop point of the vehicle 2, and stops the vehicle 2 at the stop point. The predetermined stop point is a targeted position where the vehicle 2 stops. An example of the stop point is a position where the moving object can cross the traveling road of the vehicle 2. Specific examples of the stop point are a crosswalk where a pedestrian crosses the traveling road of vehicle 2 or a stop line in front of the crosswalk, an intersection or a stop line in front of the intersection, and the like. The vehicle control device 1 presents an intention to make way for the road-crossing moving object by changing a vehicle behavior of stopping at the stop line. The road-crossing moving object is a moving object predicted to cross the traveling road of vehicle 2 at the stop point, for example, a pedestrian, a bicycle, a motorcycle, or the like.

### Details of Vehicle System

The vehicle system 100 includes an external sensor 3, a global positioning system (GPS) receiver 4, an internal sensor 5, a map database 6, a navigation system 7, an actuator 8, a human machine interface (HMI) 9, and an electronic control unit (ECU) 10.

The external sensor 3 is a detection device that detects a situation around the vehicle 2 (external situation). The external sensor 3 includes at least one of a camera and a radar sensor.

The camera is an imaging device that images the external situation of vehicle 2. For example, the camera is provided on the back side of the windshield of the vehicle 2. The camera acquires imaging information on the external situation of the vehicle 2. The camera may be a monocular camera or may be a stereo camera. The stereo camera has two imaging units arranged to reproduce binocular parallax. The imaging information of the stereo camera also includes information on the depth direction.

The radar sensor is a detection device that detects a body around the vehicle 2 using radio waves (for example, millimeter waves) or light. The radar sensor includes, for example, millimeter wave radar or LIDAR (Laser Imaging Detection and Ranging). The radar sensor transmits the radio wave or light to the surroundings of the vehicle 2, and detects the body by receiving the radio waves or light reflected from the body.

The GPS receiver 4 receives signals from three or more GPS satellites and acquires position information indicating the position of the vehicle 2. The position information includes, for example, latitude and longitude. Instead of the GPS receiver 4, other means by which latitude and longitude where the vehicle 2 is positioned may be used.

The internal sensor 5 is a detection device that detects a travel state of the vehicle 2. The internal sensor 5 includes a vehicle speed sensor, an accelerator sensor, and a yaw rate sensor. The vehicle speed sensor is a measurement device that measures a speed of the vehicle 2. As the vehicle speed sensor, for example, a vehicle wheel speed sensor is used, which is provided on vehicle wheels of the vehicle 2 or on a drive shaft rotating integrally with vehicle wheels, and measures a rotational speed of the vehicle wheels.

The accelerator sensor is a measurement device that measures an acceleration of the vehicle 2. The accelerator sensor includes, for example, a longitudinal accelerator sensor that measures acceleration in the longitudinal direction of the vehicle 2 and a lateral accelerator sensor that measures a lateral acceleration of the vehicle 2. The yaw rate sensor is a measurement device that measures a yaw rate (a rotation angular velocity) around the vertical axis at the center of gravity of the vehicle 2. As the yaw rate sensor, for example, a Gyro sensor can be used.

The map database 6 is a database that stores map information. The map database 6 is formed, for example, in a hard disk drive (HDD) mounted on the vehicle 2. The map database 6 can include a plurality of maps as the map information. A traffic rule map is an example of the map. The traffic rule map is a three-dimensional database in which traffic rules and position information on the map are associated with each other. The traffic rule map includes a lane position and a lane connection form, and the traffic rule is associated with each lane. The traffic rule includes speed limitations. That is, the traffic rule map is a database in which the speed limitation and the position are associated with each other. The traffic rule may include other general rules such as a priority road, a temporary stop, no entry, and a one-way.

The map information may include a map that includes an output signal of the external sensor 3 for using simultaneous localization and mapping (SLAM) technology. Position confirmation information (localization knowledge) used for recognizing the position of the vehicle 2 is an example of the map. The position confirmation information is three-dimensional data in which a feature point and position coordinates are associated with each other. The feature points are a point showing a high reflectance in a result of detection performed by the LIDAR or the like, a structure having a shape that produces a characteristic edge (for example, an external shape of a sign, a pole, and a curb).

The map information may include background information (background knowledge). The background information is a map in which a three-dimensional object existing as a stationary object (stationary object) whose position on the map does not change is represented by voxels.

The map information may include a traffic signal position (a traffic light location) which is three-dimensional position data of the traffic signal. The map information may include earth surface information (a surface knowledge) which is ground image data relating to a height level of the ground and the like. The map information may include trajectory information (a path knowledge) which is data representing a preferable travel trajectory defined on the road.

A part of the map information included in the map database 6 may be stored in a storage device different from the HDD storing the map database 6. A part or all of the map information included in the map database 6 may be stored in a storage device other than the storage device included in the vehicle 2. The map information may be two-dimensional information.

The navigation system 7 is a system that guides the driver of the vehicle 2 to a destination set in advance. The navigation system 7 recognizes a traveling road and a traveling lane on which the vehicle 2 travels based on the position of the vehicle 2 measured by the GPS receiver 4 and the map information in the map database 6. The navigation system 7 calculates a target route from the position of the vehicle 2 to the destination, and guides the driver to the target route using the HMI 9.

The actuator 8 is a device that performs a travel control of the vehicle 2. The actuator 8 includes at least a throttle actuator, a brake actuator and a steering actuator. The throttle actuator controls a driving force of the vehicle 2 by controlling an amount of air (throttle opening degree) supplied to the engine according to a control signal from the ECU 10. If the vehicle 2 is a hybrid vehicle or an electric vehicle, the engine actuator controls the driving force of a motor as a power source.

The brake actuator controls the brake system according to the control signal from the ECU 10 and controls a braking force applied to the wheels of the vehicle 2. For example, a hydraulic brake system can be used as the brake system. If the vehicle 2 includes a regenerative braking system, the brake actuator may control both the hydraulic braking system and the regenerative braking system. The steering actuator controls the driving of an assist motor controlling a steering torque of an electric power steering system according to the control signal from the ECU 10. In this way, the steering actuator controls the steering torque of the vehicle 2.

The HMI 9 is an interface for outputting and inputting the information between an occupant (including the driver) of the vehicle 2 and the vehicle system 100. For example, the HMI 9 includes a display panel for displaying image information to the occupant, a speaker for sound output, and operation buttons or touch panel for the occupant to perform the input operation. The HMI 9 transmits the information input by the occupant to the ECU 10. The HMI 9 displays the image information corresponding to the control signal from the ECU 10 on the display.

The ECU 10 controls the vehicle 2. The ECU 10 is an electronic control unit including a central processing unit (CPU), read only memory (ROM), random access memory (RAM), a controller area network (CAN) communication circuit, and the like. The ECU 10 is connected to a network that communicates using, for example, the CAN communication circuit, and is connected to the above-described configuration elements of the vehicle 2 so as to be able to communicate with each other. For example, the ECU 10 realizes each function of the configuration elements of the ECU 10 to be described later by inputting and outputting the data by operating the CAN communication circuit based in the signal output from the CPU, storing the data in the RAM, loading the program stored in the ROM into the RAM, and executing the program loaded in the RAM. The ECU 10 may be configured with a plurality of ECUs.

The ECU 10 includes a vehicle position recognition unit 11 (an example of a position estimation unit), an external situation recognition unit 12 (an example of a situation recognition unit), a travel state recognition unit 13 (an example of a state recognition unit), a travel plan generation unit 14, and a travel control unit 15 (an example of a control unit). The vehicle control device 1 is configured to include the vehicle position recognition unit 11, the external situation recognition unit 12, the travel state recognition unit 13, the travel plan generation unit 14, and the travel control unit 15. The travel plan generation unit 14 does not necessarily need to be included in the vehicle control device 1 but may be included in the ECU 10.

The vehicle position recognition unit 11 estimates the position of the vehicle 2. As an example, the vehicle position recognition unit 11 recognizes the position of the vehicle 2 on the map based on the position information on the vehicle 2 received by the GPS receiver 4 and the map information in the map database 6. The vehicle position recognition unit 11 may recognize the position of the vehicle 2 on the map using a method other than the above. For example, the vehicle position recognition unit 11 may recognize the position of the vehicle 2 by the SLAM technology using the position confirmation information of the map database 6 and the result of detection performed by the external sensor 3. When the position of the vehicle 2 can be measured by a sensor installed outside such as on the road, the vehicle position recognition unit 11 may recognize the position of the vehicle 2 by communicating with the sensor.

The external situation recognition unit 12 recognizes an object around the vehicle 2. The external situation recognition unit 12 recognizes a type of object detected by the external sensor 3 based on the result of detection performed by the external sensor 3 as an example. The object includes a stationary object and a moving objects. The stationary objects are objects fixed or arranged on the ground, such as guardrails, buildings, plants, signs, road paints (including stop lines, lane boundaries), and the like. The moving objects are objects accompanying movement, such as a pedestrian, a bicycle, a motorcycle, an animal, other vehicles, and the like. The external situation recognition unit 12 recognizes the objects each time the result of detection is acquired from the external sensor 3, for example.

The external situation recognition unit 12 may recognize the type of object detected by the external sensor 3 based on the result of detection performed by the external sensor 3 and the map information in the map database 6. For example, the external situation recognition unit 12 recognizes the type of object from the deviation state between the object and the ground, using the result of detection performed by the external sensor 3 and the ground information included in the map information. The external situation recognition unit 12 may apply the ground estimation model to the result of detection performed by the external sensor 3 and may recognize the type of object based on the deviation of the object from the ground. The external situation recognition unit 12 may recognize the type of object based on the result of communication. The external situation recognition unit 12 may recognize the type of moving object from the recognized objects using the background information. The external situation recognition unit 12 may recognize the type of moving object using other methods.

When the type of object is a moving object, the external situation recognition unit 12 predicts the behavior of the moving object. For example, the external situation recognition unit 12 measures the amount of movement of the moving object at that time point by applying a Kalman filter, a particle filter, or the like to the detected moving object. The amount of movement includes a movement direction and a movement speed of the moving object. The amount of movement may include a rotational speed of the moving object. In addition, the external situation recognition unit 12 may perform an error estimation of the amount of movement.

The moving object may or may not include other vehicles parked, stopped pedestrians, and the like. The movement direction of another vehicle whose speed is zero can be estimated, for example, by detecting the front of the vehicle by the image processing in the camera. Similarly, the movement direction of the pedestrian who is not moving can also be estimated by detecting the direction of the face.

Based on the type of object and the predicted behavior, the external situation recognition unit 12 determines whether or not the object is a notification target object. The notification target object is an object for presenting an intention to make way, and is a road-crossing moving object at the stop point. The external situation recognition unit 12 recognizes the predetermined stop point based on the result of recognition performed by the external sensor 3 such as a camera during the autonomous driving. The external situation recognition unit 12 may recognize the predetermined stop point referring to the map database 6 based on an autonomous driving course (trajectory) of the vehicle 2 to be described later. When the type of object is a pedestrian, a bicycle or a motorcycle and the object is predicted to cross the traveling road of vehicle 2 at the stop point, the external situation recognition unit 12 recognizes the object as the notification target object (road-crossing moving object at the stop point).

The travel state recognition unit 13 recognizes a travel state of the vehicle 2. The travel state recognition unit 13 recognizes the travel state of the vehicle 2 based on the result of detection performed by the internal sensor 5 (for example, the vehicle speed information by vehicle speed sensor, the acceleration information by the accelerator sensor, the yaw rate information by the yaw rate sensor, and the like). The travel state of vehicle 2 includes, for example, the vehicle speed, the acceleration, and the yaw rate.

The travel plan generation unit 14 generates an autonomous driving course of the vehicle 2 as a travel plan. As an example, the travel plan generation unit 14 generates the autonomous driving course of the vehicle 2 based on the result of detection performed by external sensor 3, the map information in the map database 6, the position of the vehicle 2 on the map recognized by the vehicle position recognition unit 11, the information on the object (including lane boundary) recognized by the external situation recognition unit 12, and the travel state of the vehicle 2 recognized by the travel state recognition unit 13, and the like. The autonomous driving course of the vehicle 2 includes a traveling path of the vehicle 2 and the speed of the vehicle 2. In other words, it can be said that the autonomous driving course is a speed profile indicating a relationship between the position and the speed. The autonomous driving course may be a course on which the vehicle 2 travels in a few seconds to a few minutes.

When the external situation recognition unit 12 recognizes the stop point, the travel plan generation unit 14 generates a course for stopping the vehicle 2 at the stop point. Specifically, when the road-crossing moving object around the stop point is not recognized by the external situation recognition unit 12, the travel plan generation unit 14 generates a course for stopping the vehicle 2 at a first stop position with the stop point as a reference. The first stop position is a position determined with the stop point as a reference. When the stop point is a stop line, the first stop position is a position in front of the stop line, for example, a position about 1 m in front of the position not to step on the stop line. When the road-crossing moving object around the stop point is recognized by the external situation recognition unit 12, the travel plan generation unit 14 generates a course for stopping the vehicle 2 at a second stop position in front of the first stop position. Since the second stop position is in front of the first stop position, for example, that is a position about several meters or several tens of meters in front of the stop line.

When the road-crossing moving object around the stop point is not recognized by the external situation recognition unit 12, the travel plan generation unit 14 may generate a speed profile for decelerating the vehicle 2 from a first deceleration position determined based on the stop point. The first deceleration position is a position determined based on the stop point, the current position of the vehicle 2, and the vehicle speed. When the road-crossing moving object around the stop point is recognized by the external situation recognition unit 12, the travel plan generation unit 14 may generate a speed profile for decelerating the vehicle 2 from a second deceleration position in front of the first deceleration position.

The travel control unit 15 automatically controls the traveling of the vehicle 2 based on the autonomous driving course of the vehicle 2. The travel control unit 15 outputs a control signal corresponding to the autonomous driving course of the vehicle 2 to the actuator 8. In this way, the travel control unit 15 controls the traveling of the vehicle 2 such that the vehicle 2 autonomously travels along the autonomous driving course of the vehicle 2.

The travel control unit 15 stops the vehicle 2 at the predetermined stop point based on the position of the vehicle 2 and the travel state. As an example, when the external situation recognition unit 12 recognizes the stop line, the travel control unit 15 stops the vehicle 2 at the stop point based on the position of the vehicle 2 and the travel state. As described above, when the road-crossing moving object is recognized, the travel control unit 15 stops the vehicle 2 at a position farther from the stop point compared to a case where the road-crossing moving object is not recognized. Such a change in the vehicle behavior is performed based on the course generated by the travel plan generation unit 14 according to the result of recognition performed by the external situation recognition unit 12.

The travel control unit 15 changes the vehicle behavior at the stop point depending on whether or not a road-crossing moving object is present around the stop point. Specifically, when the road-crossing moving object around the stop point is not recognized by the external situation recognition unit 12, the travel control unit 15 stops the vehicle 2 at the first stop position with the stop point as a reference. When the road-crossing moving object around the stop point is recognized by the external situation recognition unit 12, the travel control unit 15 stops the vehicle 2 at the second stop position in front of the first stop position. As above, when the road-crossing moving object is recognized, the travel control unit 15 stops the vehicle 2 at a position farther from the stop point compared to a case where the road-crossing moving object is not recognized. Such a change in the vehicle behavior is performed based on the course generated by the travel plan generation unit 14 according to the result of recognition performed by the external situation recognition unit 12.

The travel control unit 15 may change a deceleration start position as another example of changing the vehicle behavior. The deceleration start position is a position where deceleration is started to stop the vehicle 2 at the stop point. When the road-crossing moving object around the stop point is not recognized by the external situation recognition unit 12, the travel control unit 15 decelerates the vehicle 2 from a first deceleration position determined based on the stop point. The first deceleration position is a position determined based on the stop point, and the current position and the vehicle speed of the vehicle 2. When the road-crossing moving object around the stop point is recognized by the external situation recognition unit 12, the travel control unit 15 decelerates the vehicle 2 from a second deceleration position in front of the first deceleration position. As above, when the road-crossing moving object is recognized, the travel control unit 15 starts the deceleration of the vehicle 2 at a position farther from the stop point compared to a case where the road-crossing moving object is not recognized. Such a change in the vehicle behavior is performed based on the course generated by the travel plan generation unit 14 according to the result of recognition performed by the external situation recognition unit 12.

According to the vehicle system 100 described above, the vehicle 2 travels with the autonomous driving and stops at the predetermined stop point. When a road-crossing moving object is present around the stop point, the vehicle control device 1 changes the stop position of the vehicle 2 to the second stop position in front of the first stop position.

### Vehicle Stop Processing

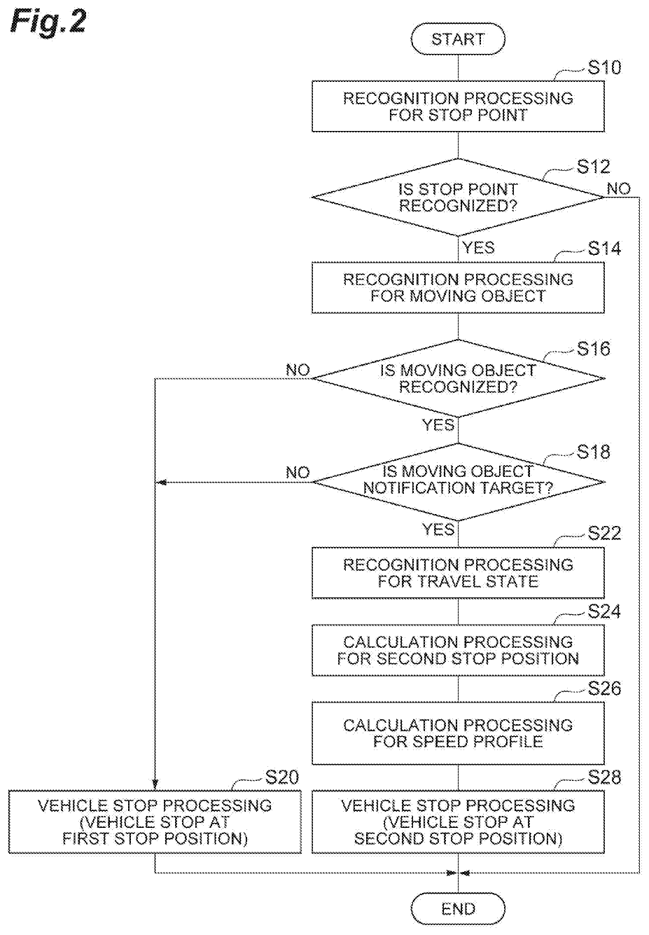

FIG. 2 is a flowchart illustrating an example of vehicle stop processing. The flowchart illustrated in in FIG. 2 is executed by the vehicle control device 1 during the autonomous driving of the vehicle 2. As an example, the vehicle control device 1 starts the flowchart in response to the occupant pressing the start button of the intention transfer mode included in the HMI 9.

As recognition processing (S10), the external situation recognition unit 12 of the vehicle control device 1 recognizes the stop point on the autonomous driving course of the vehicle 2. As an example, the external situation recognition unit 12 recognizes the stop point based on the result of detection performed by the external sensor 3. The external situation recognition unit 12 may recognize the stop point referring to the map database 6.

Subsequently, as determination processing (S12), the external situation recognition unit 12 determines whether or not the stop point is recognized in the recognition processing (S10).

When the stop point is recognized (YES in S12), as recognition processing (S14) for the moving object, the external situation recognition unit 12 recognizes the moving object being present around the stop point.

Subsequently, as determination processing (S16), the external situation recognition unit 12 determines whether or not the moving object is recognized in the recognition processing (S14).

When the moving object is recognized (YES in S16), as determination processing (S18), the external situation recognition unit 12 determines whether or not the moving object is a notification target. For example, when the type of the moving object is an animal or another vehicle, the external situation recognition unit 12 determines that the moving object is not the notification target. When the type of the moving object is a pedestrian, a bicycle or a motorcycle, the external situation recognition unit 12 determines that the moving object is a notification target candidate. When it is determined that the notification target candidate is determined to be a road-crossing moving object based on the predicted behavior of the notification target candidate, the external situation recognition unit 12 determines that the notification target candidate is the notification target. When it is determined that the notification target candidate is not a road-crossing moving object based on the predicted behavior of the notification target candidate, the external situation recognition unit 12 determines that the notification target candidate is not the notification target.

When the moving object is not present at the stop point (NO in S16), or when the moving object being present at the stop point is not the notification target (NO in S18), as vehicle stop processing (S20), the travel control unit 15 of the vehicle control device 1 stops the vehicle 2 at the first stop position. In the vehicle stop processing (S20), the travel plan generation unit 14 generates a speed profile to stop the vehicle 2 at the first stop position based on the first stop position and the current position and speed of the vehicle 2. Then, the travel control unit 15 controls the vehicle 2 according to the speed profile.

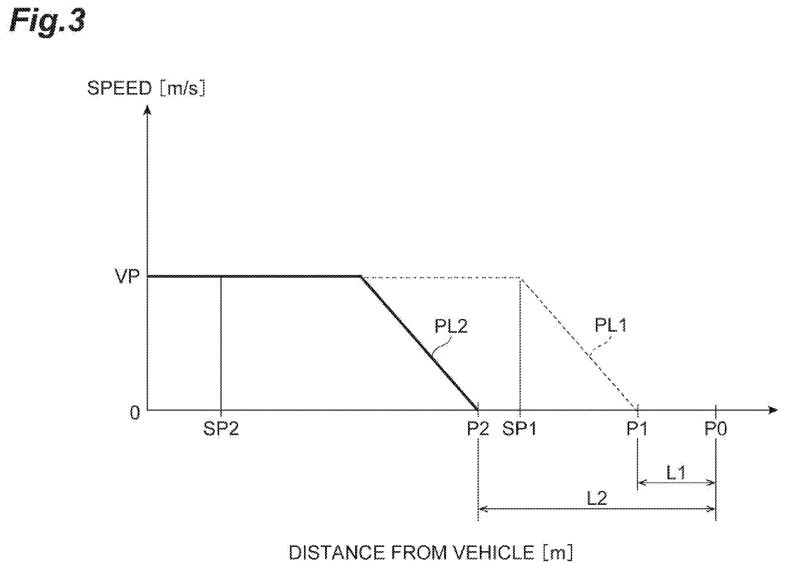

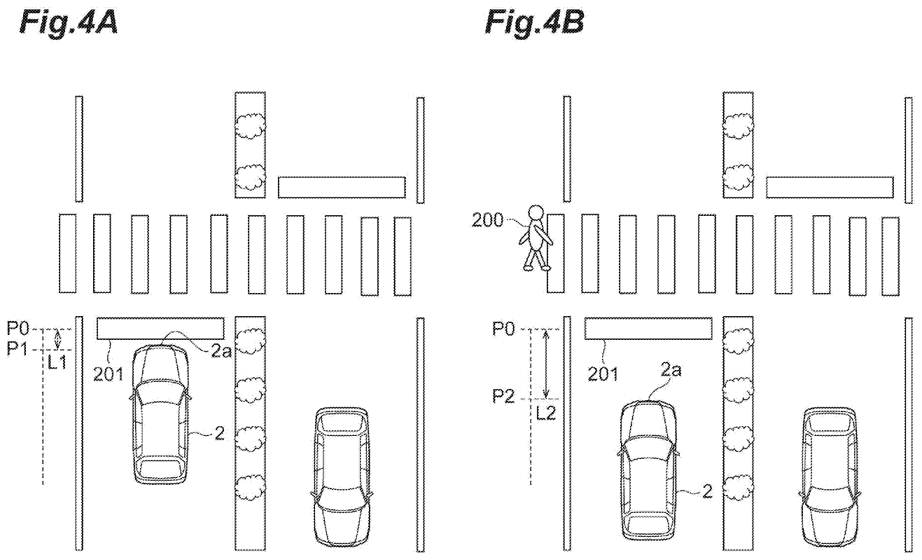

Details of the vehicle stop processing (S20) will be described with reference to FIG. 3 and FIG. 4A. FIG. 3 is a diagram illustrating an example of the speed profile. The horizontal axis represents the distance from the vehicle 2, and the vertical axis represents the speed. The vehicle 2 is traveling at a speed VP. FIG. 4A is a diagram illustrating an example of stopping the vehicle at the first stop position. FIG. 4A illustrates a scene in which a stop line 201 is a stop point P0.

As illustrated in FIG. 3, FIG. 4A, and FIG. 4B, a first stop position P1 is set at a position away from the stop point P0 by a distance L1. The travel plan generation unit 14 generates a speed profile PL1 for stopping the vehicle 2 in such a manner that a head 2a of the vehicle 2 coincides with the first stop position P1. In the speed profile PL1, the vehicle speed from the current position to the first deceleration position SP1 is the speed VP, and the speed decreases from the first deceleration position SP1, and becomes 0 km at the first stop position P1. The speed profile PL1 is same as the speed profile adopted in the normal stopping in the autonomous driving.

Returning to FIG. 2, when the moving object being present at the stop point is the notification target (YES in S18), as recognition processing (S22), the travel state recognition unit 13 recognizes the travel state of the vehicle 2. Subsequently, as calculation processing (S24), the travel plan generation unit 14 calculates a second stop position. The travel plan generation unit 14 sets a position which is several meters to several tens of meters in front of the first stop position as the second stop position.

FIG. 4B is a diagram illustrating an example of stopping the vehicle at the second stop position. As illustrated in FIG. 4B, a pedestrian 200 is present around the stop line 201 (stop point P0). In this case, the second stop position P2 is set in front of the first stop position P1. The second stop position is a position away from the stop point P0 by a distance L2.

Subsequently, as calculation processing (S26), the travel plan generation unit 14 calculates the speed profile. In FIG. 3, the speed profile PL2 for stopping at the second stop position is illustrated. As illustrated in FIG. 3, in the speed profile PL2, the vehicle speed from the current position to the second deceleration position SP2 is the speed VP, and the speed decreases from the second deceleration position SP2 and becomes 0 km at the second stop position P2. The second deceleration position SP2 is a position in front of the first deceleration position SP1. The speed profile PL2 may be decreased with the slope same as that of the speed profile PL1.

As vehicle stop processing (S28), the travel control unit 15 stops the vehicle 2 at the second stop position. The travel control unit 15 controls the vehicle 2 according to the speed profile PL2.

When the stop point is not recognized (NO in S12), when the vehicle stop processing (S20) ends, or when the vehicle stop processing (S28) ends, the vehicle control device 1 ends the processing in the flowchart illustrated in FIG. 2. The vehicle control device 1 executes the flowchart illustrated in FIG. 2 from the beginning until the ending condition is satisfied. The ending condition is satisfied, for example, when there is an instruction by the occupant to end the processing.

### SUMMARY OF EMBODIMENT

According to the vehicle control device 1, when the pedestrian 200 (an example of the road-crossing moving object) trying to cross the road around the stop point P0 is not recognized by the travel control unit 15, the vehicle 2 stops at the first stop position P1 with the stop point P0 as a reference, and when the pedestrian 200 trying to cross the road around the stop point P0 is recognized, the vehicle 2 stops at the second stop position P2 in front of the first stop position P1. That is, when the pedestrian 200 trying to cross the road around the stop point P0 is recognized, the vehicle control device 1 can present the vehicle behavior of stopping the vehicle 2 at a position away from the stop point P0 or the pedestrian 200 compared to the case where the vehicle 2 stops with the stop point P0 as a reference, to the pedestrian 200 or the like trying to cross the road. In this way, the vehicle control device 1 can also transfer the intention of the vehicle 2 to make way to the pedestrian 200 or the like who is not carrying the device. In addition, the vehicle control device 1 can present the intention to make way to the pedestrian 200 or the like who is not carrying the device without giving a feeling of discomfort.

Furthermore, according to the vehicle control device 1, when the pedestrian 200 trying to cross the road around the stop point P0 is not recognized by the travel control unit 15, the vehicle 2 starts to decelerate from the first deceleration position SP1 determined based on stop point P0, and when the pedestrian 200 trying to cross the road around the stop point P0 is recognized, the vehicle 2 starts the deceleration from the second deceleration position SP2 in front of the first deceleration position SP1. That is, when the pedestrian 200 trying to cross the road around the stop point P0 is recognized, the vehicle control device 1 can present the vehicle behavior of starting the deceleration of the vehicle 2 at a position away from the stop point P0 or the pedestrian 200 compared to the case where the vehicle 2 starts the deceleration with the stop point P0 as a reference, to the pedestrian 200 or the like trying to cross the stop point, to the pedestrian 200 or the like trying to cross the road. In this way, the vehicle control device 1 can also notify the pedestrian 200 who is not carrying the device of the intention of the vehicle 2 to make way in a more easily understandable manner.

The embodiment described above can be implemented in various forms in which various changes and improvements are made based on knowledge of those skilled in the art.

For example, in FIG. 2, the order of executing the recognition processing (S22), the calculation processing (S24) and the calculation processing (S26) may be changed.

The vehicle control device 1 may acquire the presence or absence of the road-crossing moving object at the stop point via a communication. In this case, the external situation recognition unit 12 may recognize the road-crossing moving object based on the data acquired via the communication.

What is claimed is:

1. A vehicle control device that stops a vehicle traveling with autonomous driving at a predetermined stop point, the device comprising:
a position estimation unit configured to estimate a position of the vehicle;
a state recognition unit configured to recognize a travel state of the vehicle;
a control unit configured to stop the vehicle at the stop point based on the position and the travel state of the vehicle; and
a situation recognition unit configured to recognize a road-crossing moving object being present around the stop point,
wherein the control unit is configured to stop the vehicle at a first stop position with the stop point as a reference when the road-crossing moving object around the stop point is not recognized by the situation recognition unit, and
wherein the control unit is configured to stop the vehicle at a second stop position in front of the first stop position when the road-crossing moving object around the stop point is recognized by the situation recognition unit.

2. The vehicle control device according to claim 1,
wherein the control unit is configured to decelerate the vehicle from a first deceleration position determined based on the stop point when the road-crossing moving object around the stop point is not recognized by the situation recognition unit, and
wherein the control unit is configured to decelerate the vehicle from a second deceleration position in front of the first deceleration position when the road-crossing moving object around the stop point is recognized by the situation recognition unit.
